(19) United States
(12) Patent Application Publication
(10) Pub. No.: US 2009/0171055 A1
(43) Pub. Date: Jul. 2, 2009

(54) Low temperature hydrosilylation catalyst and silicone release coatings

(76) Inventors: John Kilgour, Clifton Park, NY (US); Jos Delis, NJ Bergen op Zoom (NL); Gunnar Hoffmueller, Leverkusen (DE)

Correspondence Address: MOMENTIVE PERFORMANCE MATERIALS INC.;c/o Dilworth & Barrese, LLP, 1000 Woodbury Road, Suite 405, Woodbury, NY, 11797, US

(21) Appl. No.: 12/006,183

(22) Filed: Dec. 31, 2007

(51) Int. Cl. C08G 77/04

(52) U.S. Cl. 528/15

(57) ABSTRACT

The present invention provides novel low temperature thermal, solventless silicone release coatings for temperature sensitive films. The invention utilizes novel hydridosiloxane crosslinking fluid and hydrosilylation catalyst in conjunction with standard additives, which produce curable polysiloxane release coatings on temperature sensitive films.

### FIELD OF THE INVENTION

The present invention provides a novel branched, hydride terminated siloxane and hydrosilylation catalyst that are reactive in a polymerizing hydrosilylation reaction at low temperatures on temperature-sensitive support or film, for example, polymeric films made of polyethylene.

### BACKGROUND OF THE INVENTION

The use of hydridosiloxane fluids as crosslinking agents for the formation of silicone polymers in the reaction with vinylsiloxane polymers is the basis for a variety of applications in the silicone industry. These range from silicone gels in personal care application, to silicone elastomers in injected molding systems, to silicone polymer coating for the release industry.

Supports coated with a release silicone film can be, for example: an adhesive tape, the inner face of which is coated with a layer of pressure-sensitive adhesive and the outer face of which comprises the release silicone coating; or a paper or a polymer film for protecting the adhesive face of a self-adhesive element or pressure-sensitive adhesive; or a polymer film of the poly(vinyl chloride) (PVC), polypropylene, polyethylene or polyethylene terephthalate) type.

One of the more popular coating methods is the polymerization of a solventless solution of a polyhydridosiloxane and a polyvinylpolysiloxane by way of a hydrosilylation polymerization to form a crosslinked silicone polymer on the surface of the support or film, i.e., “release liner.”

Current hydridosiloxanes used in making release coatings are based on the equilibration of various ratios of trimethylsiloxy (M), dimethylhydridosiloxy (M^{H}), dimethyldisiloxy (D) and methylhydridodisiloxy (D^{H}) units that give substantially linear chains. These linear hydridosiloxanes with structures such as, for examples, MₐM^{vi}_{b}D_{c}D^{H}ₑ (see published U.S. Patent Application Nos.: 2005/0165194 A1 and 2005/00750020), are limited in several ways. The M^{H}/D^{H} ratio is limited by the fact that only two M^{H}′s can be present in any one molecule. This limits the amount of the fastest SiH group, which is the first to react at low temperatures. It is also limited by the inclusion of any M, which further reduces the M^{H} content.

These fluids are further limited in performance by the need for sufficient number of D and D^{H} monomers to provide high boiling point and sufficient crosslinking to rapidly form a crosslinked polymer network during the reaction with a vinyl siloxane polymer. During coating operations, the silicone coating is generally heated as a very thin film where evaporation of low molecular weight materials rapidly occurs. The physical properties of the silicone coating are dependant on the number of active D^{H} groups per molecule. Thus, the M^{H} to D^{H} ratio of any linear polymer must be low to insure sufficient crosslinking and be high enough in molecular weight not to rapidly boil away during the coating process.

While coating is currently done on paper and films such as polyester (PET) which can tolerate high temperatures, for example, 150° C. during the coating process, thermal solventless coating are difficult and very expensive to produce on temperature sensitive films such as, for example, polyethylene, poly propylene, polypropylene coated Kraft paper (PPK), polyethylene coated Kraft paper (PEK), and multilayer laminate films containing temperature sensitive components

The crosslinkable silicone release composition of the present invention gain further advantage in coating substrates that would benefit from coating at lower temperatures. Thus for example, Super Calendared Kraft (SCK) paper is currently coated at 150° C., where the high temperature causes excessive drying of the paper. Under atmospheric conditions the paper absorbs water and curls. The curling creates problems with later label attachment and label processing. Currently the industry requires a “rewetting” process with steam to prevent curling. Thus low temperature curing, as for example, less than 100° C., reduces the initial drying and obviates the need for “rewetting” to obtain flat silicone coated SCK liners.

Similarly, both paper and films with high Tg's can gain advantage using low temperature cure formulations if the energy required for curing is lower. Recently there have been significant increases in the prices of both the energy needed to provide the required cure temperature, and for the platinum used in preparing the catalyst. What is needed is a platinum catalyst that meets the curing requirements of the silicone.

As such, there remains a need in the industry for thermal solventless release coatings capable of curing at low temperatures for use on temperature sensitive films, for low energy curing, and for attaining low moisture loss, which are easy to produce and cost effective.

### SUMMARY OF THE INVENTION

The present invention provides a crosslinkable silicone release coating composition comprising:

a) at least one polyhydridosiloxane;

b) at least one organosilicon compound containing at least two aliphatic carbon-carbon multiple bonds; and,

c) a platinum containing hydrosilylation catalyst is provided comprising at least one monosiloxy unit possessing carbon-carbon double bond functionality and at least one tetrasiloxy unit,

wherein hydrosilylation polymerization between the polyhydridosiloxane and the organosilicon compound occurs below the melt temperature of a heat-sensitive support.

The release coating composition of the present invention provides a thermal solventless coating capable of hydrosilylation polymerization, to provide a crosslinked silicone polymer, on the surface of temperature-sensitive supports, such as, polyethylene, poly propylene, polypropylene coated Kraft paper (PPK), polyethylene coated Kraft paper (PEK), and multilayer laminate films containing temperature sensitive components. The silicone release coatings can optionally contain other additives, e.g., fillers, accelerators, inhibitors, pigments, surfactants, rheology modifiers, anchorage additives and the like.

### DETAILED DESCRIPTION OF THE INVENTION

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range and any combination of the various endpoints of such ranges or subranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The use of various hydridosiloxane fluids as crosslinking agents in release coatings determines some of the critical physical properties in the final polymer coating. Hydridosiloxane fluids are also critical in defining the kinetics of the polymerization reaction that generate the new silicone polymer coating.

When these hydrido functional siloxane fluids are considered from a kinetic, i.e., rate of reaction, perspective, it is found that M^{H} monomers react at lower temperatures than the D^{H} monomers. Thus, in order to minimize the hydosilylation polymerization reaction temperature, it is necessary to maximize the number of M^{H} monomers. However, only two M^{H} monomers can be incorporated into the currently used linear fluids.

The present inventors have discovered that incorporation of “T” units and/or “Q” units, e.g., methyltrisiloxy and tetrasiloxy, respectively, into a hydridosiloxane fluid create novel branched hydridosiloxy fluids that are useful in the preparation of crosslinked siloxane polymer release coatings. The addition of T and/or Q units provides for branching of the polymer having the same molecular weight and total hydride functionality with a significant increased amount of M^{H} monomers that can react at lower temperatures. These branched polymers follow the general rule that the number of M^{H} groups per molecule equals the number of T groups plus two. For example, in the formula TᵥD_{w}D^{H}ₓM^{H}_{y}, y equals v+2. Thus, for example, if v equals 0, as in the linear fluids of the prior art, only two M^{H} monomers can be incorporated in to the polymer. However, if v equals 1, then three M^{H} monomers will be in each polymer on average. As the number of T's increases the number of M^{H}'s increases. Thus, when v equals 2 there are twice as many M^{H} monomers per molecule as in the linear compounds. This increase in M^{H} concentration makes a significant increase in the reaction rate at the low temperatures required for coating temperature-sensitive supports or films.

According to an embodiment of the invention, the novel hydridosiloxane fluid of the invention has the general Formula (1):

QᵤTᵥD_{w}D^{H}ₓM^{H}_{y}M_{z} (1)

wherein:

each occurrence of Q is independently given by SiO_{4/2};

each occurrence of T is independently given by R¹SiO_{3/2} wherein each occurrence of R¹ is independently a monovalent hydrocarbon having 1 to 30 carbons;

each occurrence of D is independently given by R²R³SiO_{2/2} wherein each occurrence of R² and R³ is independently a monovalent hydrocarbon having 1 to 30 carbons;

each occurrence of D^{H} is independently given by HR⁴SiO_{2/2} wherein each occurrence of R⁴is independently a monovalent hydrocarbon having 1 to 30 carbons;

each occurrence of M is independently selected from the group consisting of R⁵R⁶RSiO_{1/2}, R⁵O_{1/2} and HO_{1/2} wherein each occurrence of R⁵, R⁶ and R⁷ is independently a monovalent hydrocarbon having 1 to 30 carbons; and

each occurrence of M^{H} is independently given by HR⁸R⁹SiO_{1/2} wherein each occurrence of R⁸ and R⁹ is independently a monovalent hydrocarbon having 1 to 30 carbons;

each occurrence of the subscripts u, v, w, x, y and z is independently an integer wherein u is from 0 to 10, v is from 0 to 10, w is from 0 to 100, x is from 1 to 100, y is from 1 to 10, and z is from 0 to 10 such that u+v equals 1 to 10, x+y equals 3 to 100, and y+z equals 3 to 10. It is understood that the hydriosiloxane can be mixtures of hydriosiloxanes of Formula (1).

In another embodiment of the present invention, each R¹, R², R³, R⁴, R⁵, R^{6,} R⁷, R⁸ and R⁹ is preferably a monovalent hydrocarbons of 1 to 20 carbon atoms, more preferably from 1 to 6 carbon atoms and most preferably 1 carbon atom; u is 0; v is preferably from 1 to 5, more preferably from 2 to 4, and most preferably 3; w is preferably from 0 to 50, more preferably from 2 to 20, and most preferably from 3 to 10; x is preferably from 1 to 50, more preferably from 3 to 25 and most preferably from 5 to 10; y is preferably from 3 to 8, more preferably from 4 to 6, and most preferably 5; and z is from 0 to 5, and more preferably 0.

In another embodiment of the present invention, each R¹, R², R³, R⁴, R⁵, R^{6,} R⁷, R⁸ and R⁹ is preferably a monovalent hydrocarbons of 1 to 20 carbon atoms, more preferably from 1 to 6 carbon atoms and most preferably 1 carbon atom; u is preferably from 1 to 5, more preferably from 2 to 4, and most preferably, 3; v is preferably 0; w is preferably from 0 to 50, more preferably from 2 to 20, and most preferably from 3 to 10; x is preferably from 1 to 50, more preferably from 3 to 25 and most preferably from 5 to 10; y is preferably from 4 to 9, more preferably from 5 to 7, and most preferably 6; and z is from 0 to 5, and more preferably 0.

Furthermore, the introduction of T and/or Q units into the hydridosiloxane polymers increases the cross-link density of the fluid. This further contributes the rapid formation of the crosslinked polymer network within the release coating and rapid cure of the coating composition at low temperatures.

Therefore, the introduction of T and/or Q monomer units into the hydridosiloxane allows for the rapid and complete cure of the crosslinked silicone polymers required for low release silicone coatings.

However, because these T and Q unit modified hydridosiloxane polymers will be used in thermal coating applications, they require a minimal molecular weight. Too low of a molecular weight means they will evaporate from the coating surface before they can react. They will also have a reduced total functionality critical to forming the required polymer network. Because of the need for a minimal molecular weight the M^{H}/D^{H} ratio in linear siloxanes has to be very low, thus slowing the reaction at low temperature. In contrast, molecules with T and/or Q monomers can contain significantly higher M^{H}/D^{H} ratios at the desired molecular weight.

An alternative approach is to use hydridosiloxane compounds with M^{H}QTD structures can be found, for example, in U.S. Pat. No. 6,158,371, however, these structures contain no D^{H} monomers, and thus their total functionality is low and the polymer network formation is difficult. As such, these hydridosiloxanes polymers are more frequently used in the production of elastomeric gels rather than for polysiloxane release coatings.

According to an embodiment of the invention, a novel hydridosiloxane fluid is provided which contains branched structures such as those possessing T or Q units and terminal SiH units (M^{H}) which can be crosslinked instantaneously at low temperature, i.e., less than or equal to 120° C., preferably less than or equal to 110° C., and more preferable of 100° C., to provide a release coating of high quality for a heat-sensitive support.

The novel polyhydridosiloxane of the present invention can be prepared by known and conventional means as one skilled in the art would recognize. These include hydrolysis of the desired chlorosilanes and acid catalysis of the required monomeric materials with catalysts such as sulfuric acid, hydrochloric acid, toluenesulfonic acid, trifloroaceticacid, acid clays and the like (see for example Noll “Chemistry and Technology of Silicones” 1968, pp 223).

According to an embodiment of the invention the polyhydridosiloxane is present in the release coating composition in an amount that ranges form 0.5 to 20 percent weight of the total release coating composition, and in another embodiment from 1 to 15 percent weight of the total release coating composition, and in yet another embodiment from 3 to 10 percent weight of the total release coating composition.

The organosilicon compounds containing aliphatic carbon-carbon multiple bonds that are used in release coating compositions of the present invention are well know in the art. Generally, the organosilicon compound is at least one silicone polymer having alkenyl groups. Although it is understood that any siloxane containing vinyl, alkenyl or alkynyl groups may be useful in this invention, they are preferably polydimethylsiloxanes having vinyl end groups; linear or branched alkenyl end groups with the carbon-carbon double bond in the terminal position; or linear or branched alkynyl end groups with the carbon-carbon triple bond in the terminal position.

Examples of these polymers may be found for example in U.S. Pat. No. 5,516,558 to O'Brien, U.S. Pat. No. 4,476,166 to Eckberg, U.S. Pat. No. 5,616,672 to O'Brien and U.S. Pat. No. 6,806,339. Broadly stated, component (b) of the present invention can be one containing two or more silicon atoms linked by divalent oxygen, hydrocarbylene or heterocarbylen radicals and containing an average of from 1 to 3 silicon-bonded monovalent hydrocarbyl or heterocarbyl radicals per silicon, with the proviso that the organosilicon compound contains at least two silicons atoms in which each silicon atom is bonded to a hydrocarbon radical containing at least one carbon-carbon multiple bond. This component can be a solid or a liquid, free flowing or gum-like.

Examples of said divalent radicals linking silicon atoms include oxygen atoms, which provide siloxane bonds, hydrocarbylene, and heterocarbonylene, hydrocarbylene containing at least one oxygen atom and/or at least one halogen atom which provide silcarbane bonds. The divalent radicals can be the same or different, as desired.

Representative non-limiting examples of suitable divalent hydrocarbylene radicals include any alkylene radical, such as —CH₂—, —CH₂CH₂—, —CH₂(CH₃)CH—, —(CH₂)₄—, —CH₂CH(CH₃)CH₂—, —(CH₂)₆— and —(CH₂)₁₈—; cycloalkylene radical, such as cyclohexylene; arylene radical, such as phenylene; and combinations of hydrocarbon radicals, such as benzylene, i.e. —C₆H₄CH₂—.

Suitable divalent heterocarbylene containing at least one oxygen atom and/or halogen atom radicals include any divalent hydrocarbylene radical in which one or more hydrogen atoms have been replaced by halogen, such as fluorine, chlorine or bromine and any divalent hydrocarbylene radical in which at least one carbon atom has been replaced with an oxygen atom. Representative non-limiting divalent heterocarbylene containing at least one oxygen atom and/or at least one halogen atom radicals include —CH₂CH₂CₙF₂ₙCH₂CH₂— wherein n has a value of from 1 to 10 such as, for example, —CH₂CH₂CF₂CF₂CH₂CH₂—, —CH₂CH₂OCH₂CH₂—, —CH₂CH₂CF₂OCF₂CH₂CH₂—, —CH₂CH₂OCH₂CH₂CH₂— and —C₆H₄OC₆H₄—.

Examples of said monovalent radicals in the organosilicon compound, i.e., component (b) include halohydrocarbyl radicals free of aliphatic unsaturation and hydrocarbyl radicals.

Examples of suitable monovalent hydrocarbyl radicals include alkyl radicals, such as CH₃—, CH₃CH₂—, (CH₃)₂CH—, C₈H₁₇—, C₁₀H₂— and C₂₀H₄₁—; cycloalophatic radicals, such as cyclohexyl; aryl radicals, such as phenyl, tolyl, xylyl, anthracyl, styryl and xenyl; aralkyl radicals, such as benzyl and 2-phenylethyl; and alkenyl radicals, such as vinyl, allyl, methallyl, 3-butenyl, 5-hexenyl, 7-octenyl, and cyclohexenyl. Alkenyl radicals are preferable terminally unsaturated. Of the higher alkenyl radicals those selected from the group consisting of 5-hexenyl, 7-octenyl, and 9-decenyl are preferred because they are of the more ready availability alpha, omega-dienes that are used to prepare the alkenylsiloxanes. Highly preferred monovalent hydrocarbon radical for the organosilicon compounds containing aliphatic carbon-carbon multiple bonds that are used in the release coatings of this invention are methyl, phenyl, vinyl and 5-hexenyl. Representative non-limiting examples of suitable aliphatically saturated monovalent halohydrocarbon radicals include any monovalent hydrocarbon radical which is free of aliphatic unsaturation and has at least one of its hydrogen atoms replaced with halogen, such as fluorine, chlorine or bromine. Preferable monovalent halohydrocarbon radicals have the formula CₙF₂₊₁CH₂CH₂— wherein n has a value of from 1 to 10, such as, for example, CF₃CH₂CH₂— and C₄F₉CH₂CH₂—.

According to an embodiment of the invention, component (b) is an organopolysiloxane containing at least two carbon-carbon multiple bonds. Said siloxane can be combined in any molecular arrangement such as linear, branched, cyclic and combinations thereof, to provide organopolysiloxanes containing at least two carbon-carbon multiple bonds and are reactive with the hydridopolysiloxane of Formula (1) in the presence of the hydrosilylation catalyst, component (c).

According to a specific embodiment of the invention, the organopolysiloxane, i.e., component (b) is a substantially linear organopolysiloxane having the general Formula (2):

XₐR¹⁰₃₋ₐSiO(X_{b}R¹⁰_{2-b}SiO)ₘ(R¹⁰₂SiO)ₙSiR¹⁰_{3-c}X_{c} (2)

wherein:

each occurrence of R¹⁰ is independently selected from the group consisting of a monovalent hydrocarbyl radical of from 1 to 20 carbon atoms and a monovalent heterocarbyl radical containing at least one halogen atom;

each occurrence of X is independently a monovalent hydrocarbyl radical of from 2 to 12 carbon atoms containing at least one carbon-carbon multiple bond;

each occurrence of the subscripts a, b, c, m and n is independently an integer wherein a is from 0 to 3; b is from 0 to 2; c is from 0 to 3, m is from 0 to 100, n is from 0 to 5000 with the proviso that a+mb+c equals to or greater than 2.

By substantially linear it is meant that the component contains no more then trace amounts of silicon atoms bearing 3 or 4 siloxy linkages. It is to be understood that the term substantially linear encompasses organopolysiloxanes, which can contain up to about 15 percent by weight cyclopolysiloxanes that are frequently co-produced with the linear organopolysiloxanes. In Formula (2), each R¹⁰ denotes a monovalent hydrocarbyl or halohydrocarbyl radical free of aliphatic carbon-carbon multiple bonds. The several R¹⁰ radicals can be identical or different, as desired.

The value of the subscript m in Formula (2) is such that the linear organopolysiloxane has a viscosity at 25° C. of at least 25 millipascal-seconds (25 cenitpose). The exact value of m that is needed to provide a viscosity value falling within said limit depends upon the identity of the X and R¹⁰ radicals. For R¹⁰₃Si-terminated polydimethylsiloxane, m will have a value of at least about 25 and the compound has at least two —SiX_{b}R_{10-b}O— units.

In terms of preferred monovalent hydrocarbon radicals, noted above, examples of preferred linear organopolysiloxanes of the above formula which are suitable for the composition of this invention include
(C₆H₅)(CH₃)(CH₂═CH)[(CH₃)₂SiO]₁₀₀Si(C₆H₅)(CH₃)(CH═CH₂),
(CH₂═CH(CH₂)₄)(CH₃)₂SiO[(CH₃)₂SiO₁₅₀Si(CH₃)₂((CH₂)₄CH═CH₂),
(CH₂═CH)(CH₃)₂SiO[Si(CH₃)₂O]₁₀₀[Si(CH₃)(CH₂CH₂CH₂CH₂CH═CH₂)O]₂—Si(CH₃)₂(CH═CH₂),
(CH₂═CH)(CH₃)₂SiO[Si(CH₃)₂O]₁₀₀[i(CH₃)(CH═CH₂)O]₂Si(CH₃)₂(CH═CH₂),
(CH₃)₃SiO[SiO(CH₃)₂SiO]₁₀₀[Si(CH₃)(CH₂CH₂CH₂CH₂CH═CH₂)O]₂Si(CH₃)₃,
(CH₃)₃SiO[SiO(CH₃)₂SiO]₁₀₀[Si(CH₃)(CH═CH₂)O]₆Si(CH₃)₃,
(CH₃)₃SiO[SiO(CH₃)(C₆H₅)SiO]₁₂₀[Si(C₆H₅)(CH═CH₂)O]₂Si(CH₃)₃,
(CH₃)₃SiO[SiO(CH₃)₂SiO]₅₀[Si(CH₃)(CH═CH₂)O]₂₀Si(CH₃)₃, and mixture thereof.

For release coating composition of this invention it is highly preferred that the linear organopolysiloxane component (b) of Formula (2) wherein the value of n is less than 0.1 m, such as, for example, zero, 0.02 m or 0.08 m. Representative non-limiting examples of highly preferred linear organopolysiloxanes (b) for adhesive-release coating compositions of this invention include
(CH₃)₃SiO[SiO(CH₃)₂SiO]₁₀₀[Si(CH₃)(CH═CH₂)O]₆Si(CH₃)₃,
(CH₃)₃SiO[SiO(CH₃)₂SiO]₂₀₀[Si(CH₃)((CH₂)₄CH═CH₂))O]₁₀Si(CH₃)₃,
(CH₂═CH(CH₂)₄)(CH₃)₂SiO[(CH₃)₂SiO]₈₀Si(CH₃)₂((CH₂)₄CH═CH₂),
(CH₂═CH)(CH₃)₂SiO[(CH₃)₂SiO]₁₅₀Si(CH₃)₂(CH═CH₂),
(CH₂═CH)(CH₃)₂SiO[Si(CH₃)₂O]₁₀₀[Si(CH₃)(CH═CH₂)O]₂Si(CH₃)₂(CH═CH₂), and mixtures thereof.

According to an embodiment of the present invention, wherein the curable composition, preferably solventless, is used to coat a solid substrate, such as paper, with an adhesive-releasing coating, the value of m plus n in the highly preferred organosilicon compound component (b) is sufficient to provide a viscosity at 25° C. for the component (b) of at least 100 mPa·s, such as from about 100 mPa·s to about 100 Pa·s, preferable from about 100 mPa·s to 10 Pa·s and, most preferably, from 100 mPa·s to 5 Pa·s; said viscosity's corresponding approximately to values of m+n of at least 60, such as from 60 to 1000, preferably to 520 and, most preferably, to 420.

Other suitable silicone polymers of the of the present invention include but are not limited to dimethylpolysiloxanes comprising dimethylvinylsilyl ends, methylvinyldimethylpolysiloxane copolymers comprising trimethylsilyl ends, methylvinyldimethylpolysiloxane copolymers comprising dimethylvinylsilyl ends, or cyclic methylvinylpolysiloxanes and the like.

The use of branched polyhydridosiloxanes of the invention as crosslinking agents makes it possible to produce release coatings on heat-sensitive supports, e.g., polyethylene (PE), polypropylene (PP), polyethylene coated Kraft paper (PEK), polypropylene coated Kraft paper (PPK) and multilayered films containing temperature sensitive materials. By virtue of the invention, crosslinking of the coating is provided at a low temperature, for example less than about 120° C. under industrial coating conditions.

The crosslinkable silicone release composition of the present invention can be deposited on any heat-sensitive support or film substrate. A heat-sensitive support or film as used herein would be a film or support that has glass transition temperature, i.e., a Tg less than about 120° C., such as, for example, PE, PP, PPK, PEK, and multilayered laminates including similar films.

The crosslinkable silicone release composition of the present invention gain further advantage in coating substrates that would benefit from coating at lower temperatures. Thus for example, SCK paper is currently coated at 150° C., where the high temperature causes excessive drying of the paper. Under atmospheric conditions the paper absorbs water and curls. The curling creates problems with later label attachment and label processing. Currently the industry requires a “rewetting” process with steam to prevent curling. Thus low temperature curing, as for example, less than 100° C., reduces the initial drying and obviates the need for “rewetting” to obtain flat silicone coated SCK liners.

Similarly, both paper and films with high Tg's can gain advantage using low temperature cure formulations if the energy required for curing is lower. Lower temperatures can save a considerable amount on the energy requirements for coating.

Furthermore, the novel polyhydridosiloxane crosslinking agents of the present invention do not modify the rheological behavior of the silicone composition, so that the coatings can be applied on any support and in particular on heat-sensitive supports and films. This property is all the more advantageous as, in the context of the invention, the silicone coating compositions can advantageously be “solvent-free.” This means that they are devoid of solvent and in particular of organic solvent. The advantages which solventless coatings provide regarding environmental concerns are easily understood to those skilled in the art.

According to one embodiment of the invention, the crosslinkable silicone release coating compositions are solvent-free. However, according to an alternative embodiment, the silicone phase of the crosslinakable silicone release coating compositions can be diluted in a solvent. In yet another embodiment of the invention the liquid silicone release coating composition is an aqueous dispersion/emulsion.

According to an embodiment of the invention, the silicone polymer (i.e., component (b), the organosilicon compound having radicals containing aliphatic carbon-carbon multiple bonds) is present in the release coating composition of the invention in an amount that ranges from 80 to 99 percent by weight of the total composition, preferably, from 85 to 99 percent by weight of the total composition, and more preferably from 90 to 98 percent by weight of the total composition.

It is preferable that the silicone polymer have a viscosity (at 25° C.) at least equal to 10 mPa·s, preferably between 50 and 1000 mPa·s. All viscosities concerned with in the present account correspond to a dynamic viscosity quantity at 25° C. referred to as “newtonian,” that is to say the dynamic viscosity which is measured, in a way known per se, at a shear rate gradient which is sufficiently low for the viscosity measured to be independent of the rate gradient.

According to an embodiment of the invention, the silicone polymer can exhibit a linear, branched or cyclic structure. Its degree of polymerization is preferably between 2 and 5000.

In an embodiment of the invention, the crossslinking polyhydridosiloxane exhibits an SiH to Si-alkenyl (Vi) molar ratio from 0.8 to 20, or 0.8 to 12 and preferably from 1.2 to 8.

Conventional platinum hydrosilylation catalysts may be used as hydrosilylation catalyst, catalyzing the addition reaction between the alkylene groups in the silicone polymer described above and the silicon-bonded hydrogen atoms in the polyhydridosiloxane crosslinking agent of the invention. In general, any hydrosilylation catalyst for addition-crosslinking silicone compositions may be used. Those preferably used are metal-containing catalysts, such as platinum, palladium, iridium, rhodium and ruthenium, with preference given to platinum and platinum compounds. Particular preference given to is given to polyorganosiloxane-soluble platinum-vinylsiloxane complexes and hexachloroplatinic acid. For example, Karstedt, U.S. Pat. Nos. 3,715,334 and 3,775,452, discloses the use of Pt(0) complex with vinylsilicon siloxane ligands as an active hydrosilylation catalyst. Additional platinum complexes, such as, complexes with platinum halides are shown by Ashby, U.S. Pat. No. 3,159,601 and Lamoreaux, U.S. Pat. No. 3,220,972. Another hydrosilylation catalyst is shown by Fish, U.S. Pat. No. 3,576,027. Fish prepares a platinum(IV) catalyst by reacting crystalline platinum(IV) chloroplatinic acid and organic silane or siloxane to form a stable reactive platinum hydrosilylation catalyst. All of the aforementioned patents are herein incorporated by reference.

However, according to a specific embodiment of the invention, a crosslinkable silicone release coating for a heat-sensitive support is prepared with at least one polyhydridosiloxane as described supra, at least one organosilicon compound having radicals containing aliphatic carbon-carbon multiple bonds as described herein, and a hydrosilylation catalyst comprising a compound having the Formula (1):

Pt_{f}(MₐM^{vi}_{b}Q_{c})_{g} (1)

wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;

each occurrence of M^{vi} is independently R²ₓR³₃₋ₓSiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;

each occurrence of Q is independently SiO_{4/2};

each occurrence of the subscripts a, b, c, f, g and x is independently an integer wherein a is 0 to 200; b is 1 to 202; c is 1 to 100; f is 1 to 100; g is 1 to 150; and x is 1 to 3.

According to another embodiment of the invention, each occurrence of M is independently R¹₃ SiO_{1/2}, wherein each occurrence of R¹ is a monovalent hydrocarbon group containing specifically from 1 to 20 carbon atoms, more specifically from 1 to 6 carbon atoms and most specifically, 1 carbon atom; R² is a monovalent hydrocarbon group containing specifically from 1 to 20 carbon atoms possessing at least one terminal carbon-carbon double bond, more specifically from 1 to 6 carbon atoms possessing at least one terminal carbon-carbon double bond and most specifically, 2 carbon atoms bonded to each other through a carbon-carbon double bond; R³ is a monovalent hydrocarbon group containing specifically from 1 to 20 carbon atoms, more specifically from 1 to 6 carbon atoms and most specifically, 1 carbon atom; a is specifically from 0 to 50, more specifically from 0 to 10, and most specifically 0; b is specifically from 1 to 50, more specifically from 2 to 15, and most specifically from 3 to 10; c is specifically from 1 to 50, more specifically from 2 to 10, and most specifically 3 to 5; f is specifically from 1 to 10, more specifically from 1 to 2, and most specifically 1; g is specifically from 1 to 20, more specifically from 1 to 4, and most specifically from 1 to 2; and x is specifically 1. It is understood that the platinum containing hydrosilylation catalyst can be composed of a single compound of Formula (1) or a mixture of compounds of Formula (1).

According to an embodiment of the invention, the hydrosilylation catalyst of the present application can be prepared by exchanging the tetramethyldivinyldisiloxane (M^{vi}M^{vi}) ligand of a platinum-complex containing at least one least, and specifically the vinylsiloxane compound having the formula Pt₂(M^{vi}M^{vi})₃, wherein M^{vi} is dimethylvinylsiloxy, i.e., Karstedt's catalyst. This preparation is achieved by mixing Karstedt's catalyst with an MₐM^{vi}_{b}Q_{c} resin, heating to achieve the exchange, and then distilling out the M^{vi}M^{vi} under vacuum. The new catalyst, Pt_{f}(MₐM^{vi}_{b}Q_{c})_{g}, is then isolated for the polymerization reaction. The catalyst may contain 0.1 to about 20 percent Pt by weight on an M^{vi}Q resin.

The amounts of these catalysts which are added to the compositions are from 0.1 to 500 ppm, preferably between 1 and 250 ppm, based on the total weight of the polyhydridosiloxane and organosilicon compound.

The use of branched polyhydridosiloxanes of the invention as crosslinking agents makes it possible to produce release coatings on heat-sensitive supports, e.g., polyethylene (PE), polypropylene (PP) and polyethylene coated Kraft paper (PEK). By virtue of the invention, correct crosslinking of the coating is provided at a low temperature, for example less than about 120° C., under industrial coating conditions.

The crosslinkable silicone release composition of the present invention can be deposited on any heat-sensitive support or film substrate. A heat-sensitive support or film as used herein would be a film or support that has glass transition temperature, i.e., a Tg less than about 120° C., such as, for example, polyethylene, poly propylene, polypropylene coated Kraft paper (PPK), polyethylene coated Kraft paper (PEK), and multilayer laminate films containing temperature sensitive components.

The crosslinkable silicone release composition of the present invention gain further advantage in coating substrates that would benefit from coating at lower temperatures. Thus for example, SCK paper is currently coated at 150° C., where the high temperature causes excessive drying of the paper. Under atmospheric conditions the paper absorbs water and curls. The curling creates problems with later label attachment and label processing. Currently the industry requires a “rewetting” process with steam to prevent curling. Thus low temperature curing (for example, less than 100° C.) reduces the initial drying and obviates the need for “rewetting” to obtain flat silicone coated SCK liners.

Similarly, both paper and films with high Tg's can gain advantage using low temperature cure formulations if the energy required for curing is lower. Lower temperatures can save a considerable amount on the energy requirements for coating.

Furthermore, the novel polyhydridosiloxane crosslinking agents of the present invention do not modify the rheological behavior of the silicone composition, so that the coatings can be applied on any support and in particular on heat-sensitive supports and films. This property is all the more advantageous as, in the context of the invention, the silicone coating compositions can advantageously be “solvent-free.” This means that they are devoid of solvent and in particular of organic solvent. The advantages, which this provides regarding environmental considerations, are easily understood to those skilled in the art.

According to one embodiment of the invention, the crosslinkable silicone release coating compositions are solvent-free. However, according to an alternative embodiment, the silicone phase of the crosslinakable silicone release coating compositions can be diluted in a solvent. In yet another embodiment of the invention the liquid silicone composition is an aqueous dispersion/emulsion.

According to an embodiment of the invention the release coating composition of the invention can include other ingredients such as, for example, adhesion-adjusting compounds; control release agents (CRA); anchorage to substrate compounds; buffering agents; surfactants; agent(s) for inhibiting hydrosilylation, preferably chosen from acetylenic alcohols and/or diallyl maleates and their derivatives, e.g., surfynol-61® (available from Air Products) ; bactericides and/or antigelling agents and/or wetting agents and/or antifoaming agents and/or fillers and/or synthetic latexes and/or colorants and/or acidifying agents and/or, rheology modifiers such as those for the control of misting and/or anchorage additives that improve the adhesion of the coating to the substrate.

These crosslinkable silicone release compositions of the invention can be applied using devices employed on industrial equipment for the coating of e.g., paper, such as a five-roll coating head, an air knife system or an equalizer bar system, to flexible supports or materials and can then be cured by moving through tunnel ovens heated to 50-200° C.; the passage time in these ovens depends on the temperature; this time is generally of the order of 1.5 to 15 seconds at a temperature of the order of 100° C. and of the order of 1.5 to 3 seconds at a temperature of the order of 180° C.

The amounts of crosslinkable silicone release compositions deposited are of the order of 0.5 to 2 g per m² of surface to be treated, which corresponds to the deposition of layers of the order of 0.5 to 2 μm.

The films, supports or materials thus coated can subsequently be brought into contact with any pressure-sensitive adhesive material of rubber, acrylic or other nature. The adhesive material is then easily detachable from the said support or material.

The following examples are given by way of indication and may not be regarded as a limitation on the scope and spirit of the invention.

### EXAMPLES

Example 1; was prepared with 100 parts of a branched vinyl terminated polysiloxane, T²(D²⁷M^{vi})₄, with a vinyl content of 1.29%, 12.1 parts of a branched hydridosiloxane, T²(D³⁵DH³⁵MH)₄, containing 0.79% hydride, so that the SiH/SiVi ratio is 2.0, 0.15% Surfinol-61(S-61), were blended and then 0.25 grams of PtM^{vi}Q catalyst No. A (containing 1% Pt on MviQ, as described herein above), was added, enough to provide 50 ppm Pt. The solution was placed in a pilot coater and used to coat a polyethylene Kraft substrate (PEK). The coating temperature was 80° C. The coating speed was varied from 50 to 100 ft/min.

Example 2: was prepared with 100 parts of a branched vinyl terminated polysiloxane, T²(D²⁷M^{v}i)₄, with a vinyl content of 1.29%, 12.1 parts of a branched hydridosiloxane, T²(D³⁵DH³⁵MH)₄, so that the SiH/SiVi ratio is 2.0, 0.15% of S-61 were blended and then 0.25 grams of PtMviQ catalyst No. B (containing 2% Pt on MviQ, as described herein above) was added, enough to provide 50 ppm Pt. The solution was placed in a pilot coater and used to coat a polyethylene Kraft substrate (PEK). The coating temperature was 80 C. The coating speed was varied from 50 to 100 ft/min.

Comparative Example 1: was prepared with 100 parts of a linear, vinyl terminated polysiloxane with a viscosity of about 250 ctks, 5.5 parts of a linear hydridosiloxane fluid with a hydride content of 1.05% hydride (SiH/SiVi:2.5/1), and 0.2% S-61 were blended and then 0.03 grams of a 10% Pt solution of Karstedt's catalyst was added, enough to provide 150 ppm Pt. The solution was placed in a pilot coater and used to coat a polyethylene Kraft substrate (PEK). The coating temperature was 80 C. The coating speed was varied from 50 to 100 ft/min.

Comparative Example 2: was prepared with 100 parts of a linear, vinyl terminated polysiloxane with a viscosity of about 250 ctks, 4.4 parts of a blend of linear hydridosiloxane fluids with an average hydride content of 1.31% hydride (SiH/SiVi:2.5/1), and 0.2% S-61 were blended and then 0.03 grams of a 10% Pt solution of Karstedt's catalyst was added, enough to provide 150 ppm Pt. The solution was placed in a pilot coater and used to coat a polyethylene Kraft substrate (PEK). The coating temperature was 80° C. The coating speed was varied from 50 to 100 ft/min.

Measurement of Cure: Samples of the coated substrate were taken. The coat weight is measured by an Oxford measurement. The amount of material remaining uncured is measure by extraction and AA analysis. Comparing the coat weight and the amount of extractable material gives the percent (%) extractable, a relative measure of cure for each experiment. Low values for extractables indicate better cure and are desirable. The results of the Examples 1 and 2 and Comparative Examples 1 and 2 are presented in Table 1.

TABLE 1

| | | | | Karstedt's | Extractables@ | Extractables@ | Extractables@ |
|---|---|---|---|---|---|---|---|
| | SiVinyl | SiH | SiH/SiVi | Pt | 50 ft/min | 75 ft/min | 100 ft/min |
| Comparative | 100 | SL6020 | 2.5 | 150 ppm Pt | 14.74 | 20.09 | 16.46 |
| Example 1 | | | | | | | |
| Comparative | 100 | SL4330 | 2.5 | 150 ppm Pt | 19.67 | 15.23 | 15.42 |
| Example 2 | | | | | | | |
| Experimental | T2(D27M^{vi})4 | SiH | SiH/SiVi | PtMviQ A | | | |
| Example 1 | 100 | T2(D35DH35MH)4 | 2 | 50 ppm Pt | 11.81 | 8.43 | 13.67 |
| | | | | PtMviQ B | | | |
| Example 2 | 100 | T2(D35DH35MH)5 | 2 | 50 ppm Pt | 2.49 | 6.09 | 9.30 |

SL6020 and SL4330 are commercially available, linear silylhydride crosslinkers. The “experimental” row displays the changes in the formulation, thus the branched vinyl siloxane was used instead of a linear one, the branched silylhydride was used in place of a linear one, and the low temperature catalyst was used in place of the standard Karstedt's catalyst.

The experiments performed with the respective component concentrations highly favoring the Comparative Example formulations. As such, the Pt catalyst level was three times higher at 150 ppm Pt in the Comparative Examples than in the Examples, which contained Pt material of only 50 ppm. Similarly the SiH/SiVinyl ratio was 2.5 for the Comparative Examples versus only 2.0 for the Examples 1 and 2. Both Comparative formulations are thus highly favored by stoichiometry to cure more rapidly and completely. The data demonstrated that the formulations of Examples 1 and 2 using the branched vinylsiloxane, branched hydride and the PtMviQ catalyst react more rapidly and more completely despite their stoichiometric composition and thus kinetic disadvantage. The data further established that temperature sensitive substrates can be silicone coated using a solventless formulation.

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

1. A crosslinkable silicone release coating composition comprising:
a) at least one polyhydridosiloxane;
b) at least one organosilicon compound having radicals containing aliphatic carbon-carbon multiple bonds; and,
c) a platinum containing hydrosilylation catalyst is provided comprising at least one monosiloxy unit possessing carbon-carbon double bond functionality and at least one tetrasiloxy unit,
wherein hydrosilylation polymerization between the polyhydridosiloxane and the organosilicon compound occurs below the melt temperature of a heat-sensitive support.

2. The silicone release coating composition of claim 1 wherein the polyhydridosiloxane composition has the formula:
QᵤTᵥD_{w}D^{H}ₓM^{H}_{y}M_{z}
wherein:
each occurrence of Q is independently given by SiO_{4/2};
each occurrence of T is independently given by R¹SiO_{3/2} wherein each occurrence of R¹ is independently a monovalent hydrocarbon having 1 to 30 carbons;
each occurrence of D is independently given by R²R³SiO_{2/2} wherein each occurrence of R² and R³ is independently a monovalent hydrocarbon having 1 to 30 carbons;
each occurrence of D^{H} is independently given by HR⁴SiO_{2/2} wherein each occurrence of R⁴ is independently a monovalent hydrocarbon having 1 to 30 carbons;
each occurrence of M is independently selected from the group consisting of R⁵R⁶R⁷SiO_{1/2}, R⁵O_{1/2} and HO_{1/2} wherein each occurrence of R⁵, R⁶ and R⁷ is independently a monovalent hydrocarbon having 1 to 30 carbons; and
each occurrence of M^{H} is independently given by HR⁸R⁹SiO_{1/2} wherein each occurrence of R⁸ and R⁹ is independently a monovalent hydrocarbon having 1 to 30 carbons;
each occurrence of the subscripts u, v, w, x, y and z is independently an integer wherein u is from 0 to 10, v is from 0 to 10, w is from 0 to 100, x is from 1 to 100, y is from 1 to 10, and z is from 0 to 10 such that u+v equals 1 to 10, x+y equals 3 to 100, and y+z equals 3 to 10.

3. The silicone release coating composition of claim 2 wherein each R¹, R², R³, R⁴, R⁵, R⁶ R⁷, R⁸ and R⁹ is a monovalent hydrocarbons of 1 to 20 carbon atoms; u is 0; v is from 1 to 5; w is from 0 to 50; x is from 1 to 50; y is from 3 to 8; and z is from 0 to 5.

4. The silicone release coating composition of claim 2 wherein each R¹, R², R³, R⁴, R⁵, R⁶ R⁷, R⁸ and R⁹ is a monovalent hydrocarbons of 1 to 20 carbon atoms; u is from 1 to 5; v is 0; w is from 0 to 50; x is from 1 to 50; y is from 4 to 9; and z is from 0 to 5.

5. The silicone release coating composition of claim 1 wherein the organosilicon compound is a silicone polymer exhibiting, per molecule, at least two alkenyl groups bonded to silicon atoms.

6. The silicone release coating composition of claim 1 wherein the organosilicon compound can exhibit a linear, branched or cyclic structure and its degree of polymerization is between 2 and 5000.

7. The silicone release coating composition of claim 1 wherein the organosilicon compound is at least one selected from the group consisting of dimethylpolysiloxanes comprising dimethylvinylsilyl ends, methylvinyldimethylpolysiloxane copolymers comprising trimethylsilyl ends, methylvinyldimethylpolysiloxane copolymers comprising dimethylvinylsilyl ends and cyclic methylvinylpolysiloxanes.

8. The silicone release coating composition of claim 1 wherein the organosilicon compound is a organopolysiloxane having the Formula:
XₐR¹⁰₃₋ₐSiO(X_{b}R¹⁰_{2-b}SiO)ₘ(R¹⁰₂SiO)ₙSiR¹⁰_{3-c}X_{c}
wherein:
each occurrence of R¹⁰ is independently selected from the group consisting of a monovalent hydrocarbyl radical of from 1 to 20 carbon atoms and a monovalent heterocarbyl radical containing at least one halogen atom;
each occurrence of X is independently a monovalent hydrocarbyl radical of from 2 to 12 carbon atoms containing at least one carbon-carbon multiple bond;
each occurrence of the subscripts a, b, c, m and n is independently an integer wherein a is from 0 to 3; b is from 0 to 2; c is from 0 to 3, m is from 0 to 100, n is from 0 to 5000 with the proviso that a+mb+c equals to or greater than 2.

9. The silicone release coating composition of claim 8 wherein the organosilicon is at least one selected from the group consisting of
(CH₃)₃SiO[SiO(CH₃)₂SiO]₁₀₀[Si(CH₃)(CH═CH₂)O]₆Si(CH₃)₃,
(CH₃)₃SiO[SiO(CH₃)₂SiO]₂₀₀[Si(CH₃)((CH₂)₄CH═CH₂))O]₁₀Si(CH₃)₃,
(CH₂═CH(CH₂)₄)(CH₃)₂SiO[(CH₃)₂SiO]₈₀Si(CH₃)₂((CH₂)₄CH═CH₂),
(CH₂═CH)(CH₃)₂SiO[(CH₃)₂SiO]₁₅₀Si(CH₃)₂(CH═CH₂), and
(CH₂═CH)(CH₃)₂SiO[Si(CH₃)₂O]₁₀₀[Si(CH₃)(CH═CH₂)O]₂Si(CH₃)₂(CH═CH₂).

10. The silicone release coating composition of claim 1 wherein the platinum containing hydrosilylation catalyst has the formula:
Pt_{f}(MₐM^{vi}_{b}Q_{c})_{g}
wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;
each occurrence of M^{vi} is independently R²ₓR³₃₋ₓSiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;
each occurrence of Q is independently SiO_{4/2};
each occurrence of the subscripts a, b, c, f, g and x is independently an integer wherein a is 0 to 200; b is 1 to 202; c is 1 to 100; f is 1 to 100; g is 1 to 150; and x is 1 to 3.

11. The silicone release coating composition of claim 10 wherein each occurrence of M is independently R¹₃ SiO_{1/2}, wherein each occurrence of R¹ is a monovalent hydrocarbon group containing from 1 to 6 carbon atoms, R² is an monovalent hydrocarbon group containing from 1 to 6 carbon atoms possessing at least one terminal carbon-carbon double bond, R³ is a monovalent hydrocarbon group containing from 1 to 6 carbon atoms, each a, b, c, f, g and x is an integer, wherein a from 0 to 10; b is from 2 to 15, c is from 2 to 10, f is from 1 to 2, g is from 1 to 4, and most specifically from 1 to 2; and x is 1.

12. The silicone release coating composition of claim 10 wherein said catalyst is a single compound of said formula or a mixture of compounds of said formula.

13. The silicone release coating composition of claim 10 wherein R¹ is methyl, R² is vinyl and R³ is methyl.

14. The silicone release coating composition of claim 10 wherein said catalyst is a solid.

15. The compound resulting from the crosslinking of the silicone release coating composition of claim 1.

16. The compound resulting from the crosslinking of the silicone release coating composition of claim 2.

17. The compound resulting from the crosslinking of the silicone release coating composition of claim 3.

18. The compound resulting from the crosslinking of the silicone release coating composition of claim 4.

19. The compound resulting from the crosslinking of the silicone release coating composition of claim 8.

20. The compound resulting from the crosslinking of the silicone release coating composition of claim 9.

21. The compound resulting from the crosslinking of the silicone release coating composition of claim 10.

22. The composition of claim 1 applied to a surface of a polymeric substrate having a Tg of not greater than about 120° C.

23. The composition of claim 2 applied to a surface of a polymeric substrate having a Tg of not greater than about 120° C.

24. The composition of claim 3 applied to a surface of a polymeric substrate having a Tg of not greater than about 120° C.

25. The composition of claim 4 applied to a surface of a polymeric substrate having a Tg of not greater than about 120° C.

26. The composition of claim 8 applied to a surface of a polymeric substrate having a Tg of not greater than about 120° C.

27. The composition of claim 9 applied to a surface of a polymeric substrate having a Tg of not greater than about 120° C.

28. The composition of claim 10 applied to a surface of a polymeric substrate having a Tg of not greater than about 120° C.

29. The substrate of claim 22 wherein the silicone release coating composition is crosslinked.

30. The substrate of claim 23 wherein the silicone release coating composition is crosslinked.

31. The substrate of claim 24 wherein the silicone release coating composition is crosslinked.

32. The substrate of claim 25 wherein the silicone release coating composition is crosslinked.

33. The substrate of claim 26 wherein the silicone release coating composition is crosslinked.

34. The substrate of claim 27 wherein the silicone release coating composition is crosslinked.

35. The substrate of claim 28 wherein the silicone release coating composition is crosslinked.

36. The silicone release coating composition of claim 1 wherein the support to be coated is made of a heat-sensitive material selected from the group consisting of polyethylene (PE), polypropylene (PP), polypropylene coated Kraft paper (PPK), polyethylene coated Kraft paper (PEK) and multilayer laminate film made with temperature sensitive components.

37. The silicone release coating composition of claim 1 wherein the polyhydridosiloxane is present in the release coating composition in an amount that ranges form 0.5 to 20 weight percent of the total silicone release coating composition.

38. The silicone release coating composition of claim 1 wherein the polyhydridosiloxane is present in the release coating composition in an amount that ranges form 1 to 12 weight percent of the total silicone release coating composition.

39. The silicone release coating composition of claim 1 wherein the organosilicon compound is present in an amount that ranges from 80 to 99 weight percent of the total silicone release coating composition.

40. The silicone release coating composition of claim 1 wherein the organosilicon compound is present in an amount that ranges from 90 to 98 weight percent of the total silicone release coating composition.

41. The silicone release coating composition of claim 1 wherein the polyhydridosiloxane exhibits an SiH to Si Vi molar ratio 0.8 to 20.

42. The silicone release coating composition of claim 1 wherein the polyhydridosiloxane exhibits an SiH to Si Vi molar ratio 1.2 to 8.

43. The silicone release coating composition of claim 1 further comprising at least one additional compound selected from the group consisting of adhesion-adjusting compounds; control release agents; anchorage to substrate compounds; buffering agents; surfactants; agent(s) for inhibiting hydrosilylation; bactericides; anti gelling agents; wetting agents; anti foaming agents; fillers; synthetic latexes; colorants; acidifying, rheology modifying and anchorage additive agents.

44. The silicone release coating composition of claim 1 wherein the catalyst is present in an amount that ranges from 0.1 to 500 ppm.
